(19) United States
(12) Patent Application Publication
(10) Pub. No.: US 2007/0121604 A1
(43) Pub. Date: May 31, 2007

(54) Lightweight Voice Over Internet Protocol Phone

(75) Inventors: Praphul Chandra, Bangalore (IN); David Lide, Rockville, MD (US); Manoj Sindhwani, Oak Hill, VA (US); Satish Mundra, Germantown, MD (US); Samant Kumar, Germantown, MD (US); Keith Gerard Krasnansky, Germantown, MD (US); Thomas Hudson McKinney, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/552,785

(22) Filed: Oct. 25, 2006

Related U.S. Application Data
(60) Provisional application No. 60/730,475, filed on Oct. 26, 2005.

(51) Int. Cl. H04L 12/66

(52) U.S. Cl. 370/356

(57) ABSTRACT

Disclosed above are various embodiments of VoIP communication systems that utilize low cost IP phones that rely on a centralized VoIP controller for much of the processing. Reducing the processing taking place on an IP phone may reduce the number of components that need to be on the IP phone which may result in a less expensive IP phone in terms of both cost and power. When the IP phone is embodied as a WIPP, the reduced processing may also result in more efficient communication between the WIPP and an AP. The increased communication efficiency may result in less power being used by the WIPP and effectively extend the battery life. Since a number of redundant components have been centralized, the VoIP system as a whole may be less costly. Also, centralized control may provide greater functionality and versatility in the setup and configuration of a VoIP communication system.

### CROSS-REFERENCE TO RELATED APPLICATIONS

This application claims priority to U.S. Provisional Application No. 60/730475, filed Oct. 26, 2005, entitled “Thin Client for Voice Over Wireless Local Area Networks”, Prophul Chandra et al., which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

With the recent development and widespread availability of broadband internet connections, many new voice, video, and data services are being offered that take advantage of the additional bandwidth. One such voice service is the voice over internet protocol (VoIP), which enables the routing of voice conversations over internet protocol (IP) networks such as the internet. Bypassing the traditional packet switched telephone network (PSTN), consumers may make free VoIP-to-VoIP calls anywhere in the world with an internet connection and consumers may gain significant cost savings with PSTN-to-VoIP or VoIP-to-PSTN calls.

Typical home VoIP systems have one or more wireless IP phones (WIPP) that wirelessly connect to an IP network access point (AP). In these VoIP systems, the AP merely acts as a bridge to connect the wireless network and the IP network with all of the functionality for enabling a VoIP conversation resident on each WIPP in the system.

### SUMMARY

Disclosed herein is a central voice over internet protocol (VoIP) controller. The central VoIP controller comprises a communication driver configured to communicate raw digital audio data in accordance with a communication protocol and an audio processor configured to process digital audio data. The central VoIP controller further comprises an audio hub configured to append headers to the digital audio data and to route outgoing audio data over an internet protocol (IP) network and depacketize incoming audio data from the IP network. The central VoIP controller also comprises an IP network interface configured to communicate packetized digital audio data.

Also disclosed herein is an IP phone configured to communicate VoIP calls. The IP phone comprises a communication driver configured to send and receive raw digital audio data in accordance with a communication protocol, a digital-to-analog (D/A) converter for converting received raw digital audio data into audio signals, and a speaker for audibly outputting the audio signals converted by the D/A converter. The IP phone further comprises a microphone for detecting ambient audible sounds as audio signals and an analog-to-digital (A/D) converter for converting the ambient audio signals into the raw digital audio data that is sent by the communication driver.

Further disclosed herein is a VoIP communication method. The method comprises at least one IP phone communicating to send raw digital audio data and user input data and receive raw digital audio data and graphical user interface (GUI) data. The method also comprises a central VoIP controller communicating to receive the raw digital audio data and the user input data sent by the at least one IP phone and receive incoming digital audio data from an internet protocol (IP) network. The central VoIP controller processes the received raw digital audio data and the incoming digital audio data. The central VoIP controller sends the processed incoming digital audio data that is the received raw digital audio data on the at least one IP phone and sends the GUI data responsive to received user input data with the central VoIP controller. The central VoIP controller routes the processed raw audio data over the IP network.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 illustrates an embodiment of a voice over internet protocol (VoIP) communication system.

FIG. 2 illustrates multiple wireless IP phones (WIPPs) communicating through a voice enabled access point (VoAP).

FIG. 3 illustrates an embodiment of a VoAP with direct connections to both an internet protocol (IP) network and the public switched telephone network (PSTN).

FIG. 4 illustrates another embodiment of a VoIP communication system.

FIG. 5 illustrates another embodiment of a VoIP communication system.

FIG. 6 illustrates an exemplary general purpose computer system suitable for implementing the several components of the disclosure.

### DETAILED DESCRIPTION

It should be understood at the outset that although an illustrative implementation of one embodiment of the disclosure is illustrated below, the system may be implemented using any number of techniques, whether currently known or in existence. The disclosure should in no way be limited to the illustrative implementations, drawings, and techniques illustrated below, including the exemplary design and implementation illustrated and described herein, but may be modified within the scope of the appended claims along with their full scope of equivalents.

Previously, all of the functionality for enabling VoIP calls resides on each IP phone. As used herein, an IP phone may broadly refer to the category of devices that connect to an IP network for establishing VoIP calls via wired connections such as Ethernet or differential line connections, or via wireless connections such as WIFI or Bluetooth connections. An IP phone that connects to an IP network via a wireless connection may be referred to as a wireless IP phone (WIPP). Each IP phone includes one or more signal processors to provide echo cancellation, encode and decode audio signals with an audio codec, and other audio processing features. Also, each IP phone may include sufficient processing power and memory for executing a self-sustaining graphical user interface (GUI). The memory requirements for implementing a GUI on each IP phone may be extensive due to needing to store all of the GUI icons, images, screen layouts, process flows, supporting data, etc. Further, since all of the VoIP functionality is resident on each IP phone, then each IP phone is responsible for performing all of the signaling functions for establishing a VoIP call. When the IP phone is embodied as a WIPP, the communication overhead between the WIPP and a wireless access point (AP) may be large due to needing to communicate all of the real-time transport protocol (RTP), user datagram protocol (UDP), and IP headers required for routing the VoIP call.

Having all of the functionality required for a VoIP call resident on each IP phone results in an expensive system not only in terms of monetary cost for redundantly enabling processing and memory requirements on each IP phone, but also in terms of high power consumption. The high power consumption may result from executing the complex processing functions on each IP phone, sustaining the large memory with read, write, and refresh operations, and each IP phone maintaining high power states for long periods in order to perform signaling functions for establishing a VoIP call. When embodied as a WIPP, high power consumption may also result from long communication times between the WIPP and a corresponding AP due to the large communication overhead.

Disclosed herein is a voice over internet protocol (VoIP) communication system that offloads much of the processing from an IP phone to a centralized VoIP controller. The VoIP controller may be implemented as any of a voice enabled AP (VoAP), voice enable PC (VoPC), IP private branch exchange (IP-PBX), or any other central controller for providing a majority of processing for enabling VoIP calls. Reducing the processing taking place on an IP phone may reduce the number of components that need to be on the IP phone. When embodied as a WIPP reducing the processing taking place on the WIPP may also result in more efficient communication between the WIPP and an AP. More efficient communication may be achieved by the WIPP not needing to communicate VoIP routing data or perform some or all of the signaling functions for establishing a VoIP call. The increased communication efficiency and the reduced number of components implemented on the WIPP results in less power being used by the WIPP and effectively extends the battery life and possible communication duration. Further, since a number of redundant components have been centralized, each of the IP phones as well as the VoIP system as a whole may be less costly. Also, centralized control may provide greater functionality and versatility in the setup and configuration of a VoIP communication system that may not be limited by the feature set available through an RJ-11 interface.

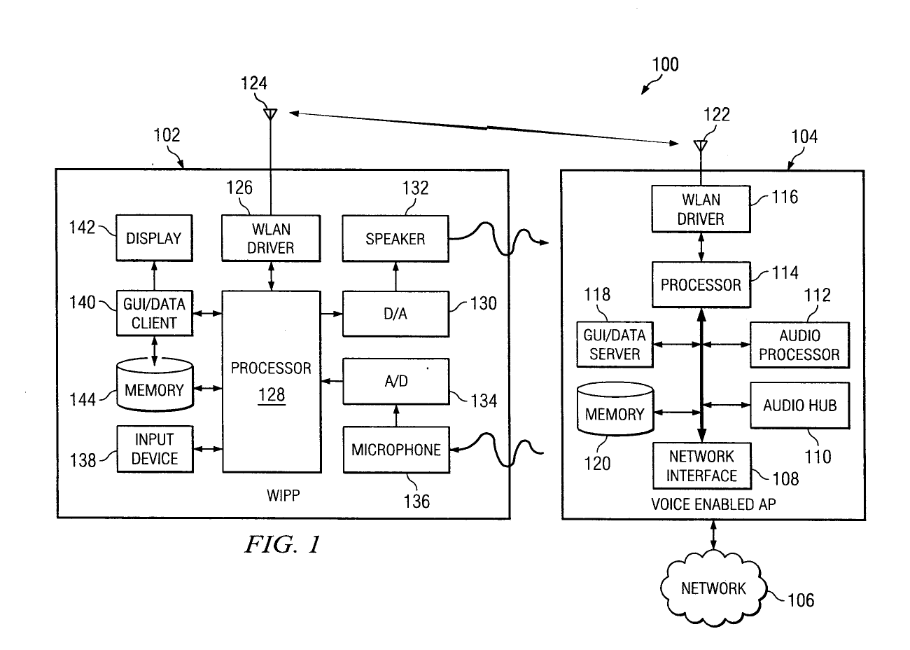

FIG. 1 illustrates one embodiment of a VoIP communication system 100. The VoIP communication system 100 includes a WIPP 102, a voice enabled access point (VoAP) 104, and an IP network 106. The IP network 106 may be any wired or wireless IP network such as a local area network (LAN), the internet, a wireless network outside the range of the WIPP, or any combination thereof. For example, the VoAP 104 may connect to an ad-hoc wireless network that is one or more hops away from an internet connection.

In one embodiment, the VoAP 104 includes all of the functionality for enabling one or more VoIP calls and coordinating the calls with one or more WIPPs 102. The VoAP 104 includes a network interface 108, an audio hub 110, an audio processor 112, a processor 114, a wireless communication driver 116, one or more antennas 122, a GUI/Data server 118, and a memory 120.

Each of the components of the VoAP 104 are discussed in more detail below. The network interface 108 connects the VoAP 104 to the network 106. The network interface 108 may be implemented as an Ethernet port, a universal serial bus (USB) port, or any other wire line network interface. Alternatively, the network interface 108 may simply be implemented using the wireless communication capabilities of the VoAP 104 to connect to another wireless network as described above. The audio hub 110 enables the VoAP 104 to send and receive VoIP calls over the network 106. The audio processor 112 performs most or all of the audio processing functions such as encoding and decoding the audio data in accordance with a codec, performing echo cancellation, tone generation, and tone detection. The processor 114 provides a central control for sending and receiving audio data to a corresponding WIPP as well as coordinating graphical user interface (GUI) or data requests described in more detail below. The wireless communication driver 116 enables the wireless communication between the VoAP 104 and the WIPP 102 through any wireless communication protocol such as bluetooth or the 802.11x standards. 802.11x is a general designation of any one or a combination of the 802.11 standards. The GUI/Data server 118 acts as a web server or daemon browser to provide GUI functionality and data services to each of the WIPPs 102 connected to the VoAP 104. The memory 120 stores all of the data necessary to support the GUI/data server 118 as well as storing data in a central location that may be shared between each WIPP 102 connected to the VoAP 104.

In the embodiment illustrated in FIG. 1, the WIPP 102 simply has the functionality to send and received digital audio data and interact with a user. The WIPP 102 includes an antenna 124, a wireless communication driver 126, a processor 128, a digital-to-analog (D/A) converter 130, a speaker 132, an analog-to-digital (A/D) converter 134, a microphone 136, a GUI/Data client 140, a display 142, and a small memory 144. In the embodiment shown in FIG. 1, the WIPP 102 does not include any self-sustaining GUI functions and does not perform a majority of audio processing or VoIP routing functions.

Each of the components of the WIPP 102 are discussed in more detail below. The wireless communication driver 126 enables the wireless communication between the WIPP 102 and the VoAP 104. The processor 128 provides a central control for sending and receiving audio data to the VoAP 104 as well as coordinating GUI or data requests in accordance with user inputs. The D/A converter 130 enables received audio from a VoIP call to be output from the speaker 132 so that a user of the WIPP 102 may hear incoming audio. The A/D converter 120 converts ambient audio received from the user of the WIPP 102 through the microphone 122 into digital signals that may be sent to the VoAP 104 for processing and routing. Various user input may be provided to the WIPP through the input device 138 to initiate a VoIP call, accept/reject an incoming call, navigate a GUI on the display 142 or perform any other operations requiring user input. The GUI/Data client 140 acts as a web browser or HTTP client to display a GUI on the display 142 for interacting with a user to control the operations of the WIPP 102. The memory 144 is a small memory that may store data in support of the operation of the WIPP 102.

The GUI/data client 140 displays various GUI screens for controlling the operation of the WIPP 102 in accordance with user inputs on the input device 138. Upon receiving user inputs, the processor 128 may display the user inputs on the display 142 via the GUI/data client 140. For example, as a user enters in a telephone number, the number that the user is inputting may be displayed on the display 142. By displaying the user inputs as the input device 138 is manipulated, the user may have visual feedback of what they are entering.

Upon receiving user inputs, the processor 128 may also communicate the inputs to the VoAP 104 via the wireless communication driver 126. Upon receiving navigational user inputs, the processor 114 may pass them to the GUI/Data server 118 to be processed. For example, if a user manipulates the input device 138 to navigate to a different GUI screen, then the inputs may be communicated to the GUI/Data server 118. Upon receiving the user inputs, the GUI/Data server 118 may fetch the corresponding GUI screen and any supporting data from the memory 120 and communicate the fetched GUI screen and data to the WIPP 102 to be displayed on the display 142.

Upon receiving operational user inputs, the processor 114 may pass them to the audio hub 110. For example, a user may initiate a VoIP call by manipulating the input device 138. Upon receiving the user inputs, the processor 114 may pass the inputs to the audio hub 110 to initiate a VoIP call. Alternatively, when receiving a call, a caller ID or other visual feedback, in addition to audio and/or kinetic feedback may alert a user of the WIPP 102 of an incoming call. A user may provide inputs on the input device 138 to either accept or reject the call. Based on the inputs provided by the user, the audio hub 110 may either connect the call, forward to voicemail, or simply send a message back to the initiating device that the call is rejected, such as through a 480 message in session initiation protocol (SIP).

When making a VoIP call, a user of the WIPP 102 may initiate communication with the VoAP 104 and wait for the VoAP 104 to establish the call. The communication with the VoAP 104 may be initiated by the user manipulating the input device 138 to dial a telephone number, enter in a VoIP identification, or select a name from a call list displayed by the GUI/Data client 140. The processor 128 may interpret the inputs and send a request to initiate a VoIP call to the VoAP 104. Upon receiving the request to send a VoIP call, the VoAP 104 may perform all or most of the functions necessary for initiating a VoIP call. The audio hub 110 may initiate a VoIP call in accordance with the SIP, H.323 protocol, or any other appropriate VoIP communication protocol. For example, using SIP, the audio hub 110 may send the “invite” request to the desired recipient using the 100 trying and 180 ringing messages. Upon receiving an acknowledgment “ACK” from the recipient, using the 200 OK message, the voice communication may commence. Since the call initiation is handled by the VoAP 104 the WIPP 102 may enter a low power mode between sending the call request to the VoAP 104 until the 200 OK message is received. If the call request fails then the VoAP 104 may wake up the WIPP 102 for a short time to display a message on the WIPP 102 that the call has failed using the GUI/Data client 140.

Similar to sending a VoIP call, the VoAP 104 handles much of the processing necessary for receiving a VoIP call. For example, again using SIP, the audio hub 110 may receive an “invite” request from a caller and send a message to the WIPP 102 to begin ringing. After sending the message to the WIPP 102, the audio hub 110 may reply to the “invite” request with a 180 ringing message. Upon a user manipulating the input device 138 on the WIPP 102 to answer the call, the processor 128 may interpret the input and send an indication to answer the VoIP call to the VoAP 104. The audio hub 110 may then send the 200 OK message to the caller to commence the voice communication. Since the call initiation is handled by the VoAP 104 the WIPP 102 may stay in a low power mode unit it receives an indication to start ringing from the VoAP 104. After receiving the indication to start ringing, the WIPP 102 may be in a partially awake state to signal a user using audio, visual, and/or kinetic feedback that there is an incoming call. After receiving user inputs to accept the call the WIPP 102 may fully awaken.

Upon a VoIP call being established much of the audio processing is handled by the VoAP 104. The A/D converter 134 may sample and digitize any audio signals detected by the microphone 136, such as the voice of a user of the WIPP 102. The processor 128 may then communicate the raw digital audio to the VoAP 104 via the WLAN driver 126. As used herein, raw digital audio data refers to digital audio data that has not had a majority of processing applied or does not require a majority of decoding or processing prior to being converted into audio signals by a D/A converter and output by a speaker. In other words, the majority of the audio processing occurs on the VoAP 104 as described below. Upon the VoAP 104 receiving the raw digital audio from the WIPP 102, the audio processor 112 may processes the digital audio. The audio processor 112 may operate to process the received audio data as if it was directly input from the A/D converter 134. The audio processor 112 may encode the digital audio data in accordance with any appropriate codec, performing echo cancellation, and any other audio processing functions. In some embodiments, the WIPP 102 may perform some of the audio processing described above with the majority of audio processing occurring on the VoAP 104. The audio hub 110 may then append the encoded audio data with any necessary real-time transport protocol (RTP), user datagram protocol (UDP), and IP headers in order to properly route the audio data to the intended recipient. In some embodiments, the WIPP 102 may append the raw digital audio data with an IP header and possibly a UDP and RTP header prior to wirelessly communicating the raw digital audio data to the VoAP 104. For example, when communicating using the Bluetooth protocol, the raw digital audio data may be communicated by the WIPP 102 without any IP, RTP, or UDP headers. When communicating using a WIFI protocol, the raw digital audio data may be communicated by the WIPP 102 with an IP header and possibly a UDP and RTP header by the WIPP 102. When the digital audio data already has one or more headers then the audio hub 110 may append the audio data with any additional headers needed to properly route the audio data to the intended recipient.

Similar to sending audio, the audio hub 110 may receive audio communications. The received audio communication may be depacketized by the audio hub 110 and the resultant audio data may be decoded and processed by the audio processor 112. The processor 114 may then communicate the raw digital audio to the WIPP 102 via the wireless communication driver 116. Upon the WIPP 102 receiving the raw digital audio from the VoAP 104, the D/A converter 130 may convert the digital audio to an analog signal that may be projected by the speaker 132.

Since a majority of the audio processing and VoIP routing functions are performed by the VoAP 104 as described above, less processing is performed on the WIPP 102 which may cause a reduction in the amount of power used by the WIPP 102 as well as a reduction in its cost. Further, because a majority of the VoIP routing functions are performed by the VoAP 104, the wireless communication overhead between the VoAP 104 and the WIPP 102 may be reduced. The reduced communication overhead is due to the WIPP 102 not needing to communicate some or all of the RTP, UDP, and IP headers along with the audio data to the VoAP 104. The reduction in the communication overhead between the WIPP 102 and the VoAP 104 may translate into less time actively communicating data. If the WIPP 102 transitions to a low power state when it is not actively communicating, then the reduced communication overhead may result in the WIPP 102 using less power.

As stated above, the wireless communication between the WIPP 102 and the VoAP 104 may use any wireless communication protocol, such as Bluetooth or the 802.11 standards. In order to ensure quality of service (QoS), the communication protocol implemented by the wireless communication driver 116 may utilize a wireless multi-media scheduled access (WMM-SA) scheme. For example, the communication protocol may provide scheduled access through a prioritization scheme such as that defined in the 802.11e standard to give higher priority to voice communication. Alternatively, in order to ensure QoS, the communication protocol may provide scheduled access through a dedicated voice communication channel as is used in the Bluetooth standard. As another measure to ensure QoS, a jitter buffer may be used on the VoAP 104 to mitigate the effects of jitter in the communication between the WIPP 102 and the VoAP 104. Jitter refers to the variation in the delay between received packets of data and may result in audio packets being received out of order or with audibly noticeable delay. To mitigate the effects caused by jitter, the VoAP 104 may buffer incoming audio data packets in memory 120 or another memory (not shown) in order for the audio processor 112 to restructure the audio data for improved playback. In one embodiment, a jitter buffer may also be used on the WIPP 102 to mitigate any jitter occurring between the WIPP 102 and the VoAP 104.

Security of voice conversations may be enabled by the audio data being encrypted/decrypted by the audio processor 112 over the communication path between the VoAP 104 and a corresponding VoIP device. Alternatively, encryption/decryption may be handled by each WIPP 102 to ensure protected communication across the entire communication path. Also, security features within the wireless communication protocol, such as the 802.11i standard, may be used to ensure security between the WIPP 102 and the VoAP 104.

Having the memory 120 on the VoAP 104 provides many advantages over conventional VoIP systems. In general, the memory 120 may include any data that may otherwise be redundantly stored on each WIPP 102. The data stored in the memory 120 may include data that may be used to implement a GUI on the WIPP 102 such as GUI icons, images, screen layouts, process flows, as well as any supporting data for the GUI such as address book entries, instant messaging buddy lists, etc. Storing data in the central location of the memory 120 allows each of the WIPPs 102 that connect to the VoAP 104 to have shared access to all or a portion of the data in the memory 120.

Services may also be provided for keeping the data stored in the memory 120 up to date. For example, the data in the memory 120 may be synchronized with external applications that may be on the network 106. For example, if a personal computer (PC) was connected to the VoAP 104 through a LAN then the VoAP 104 may synchronize any address book entries in the memory 120 with an address book application running on the PC, such as MICROSOFT OUTLOOK. Another service may include the VoAP 104 manufacturer or a VoIP service provider performing automatic updates with the GUI data stored in the memory 120. The updates may include new images, layouts, or process flows to let the WIPP 102 take advantage of all the latest features available from the VoAP 104 manufacturer or a VoIP service provider. Updates may also be automatically provided to maintain an up-to-date appearance of the GUI by periodically updating the appearance of the GUI to coincide with current events or recent user activities.

The central memory 120 may also allocate individual space for each WIPP 102 or each VoIP user to allow for personalization and the creation of user profiles. For example, by manipulating the GUI on the WIPP 102, a VoIP user may log in to the VoAP 104 using their VoIP service provider user identification or any other identification. Based on the information entered, the GUI on the WIPP 102 may be displayed according to the customized preferences of the user. User customizations may include changing color schemes, fonts, screen layout, welcome messages, or any other feature of how data is displayed to the user. Each user may also store customized GUI support data such as custom address book entries or instant messaging buddy lists, for example. Having VoIP account based profiles as described above may also enable administrative functions such as parental controls to be applied to each user that connects through the VoAP 104. Administrative functions may include designating what calling features may be used through the VoAP 104, the categories of phone numbers that may be called (e.g., information 411, pay-by-minute 900 numbers, only VoIP users), limiting the amount of time each user is allowed for a given period of time (e.g., five hours per week), or controlling any other features of the WIPP 102 or the VoIP service.

The GUI/Data server 118 also provides many advantages over prior art VoIP systems. While the GUI/Data server 118 may host a GUI application to be shown on the display 142 for enabling a user to control the WIPP 102 as described above, the GUI/Data server 118 may also connect to the network 106 to provide additional services. For example, if the GUI/Data server 118 connects to the internet then the WIPP 102 may additionally be able to perform web browsing and instant messaging functions via the GUI/Data server 118.

Since the WIPP 102 is only limited by what is displayed by the GUI/Data server 118, the VoIP communication system 100 may have an increased feature set over the traditional features that are limited by signaling over an RJ-11 interface. As cellular phones are increasingly being designed to operate on both cellular and WLAN networks, one new feature may be to enable a call handover between the WIPP 102 to a cell phone or cell phone to the WIPP 102.

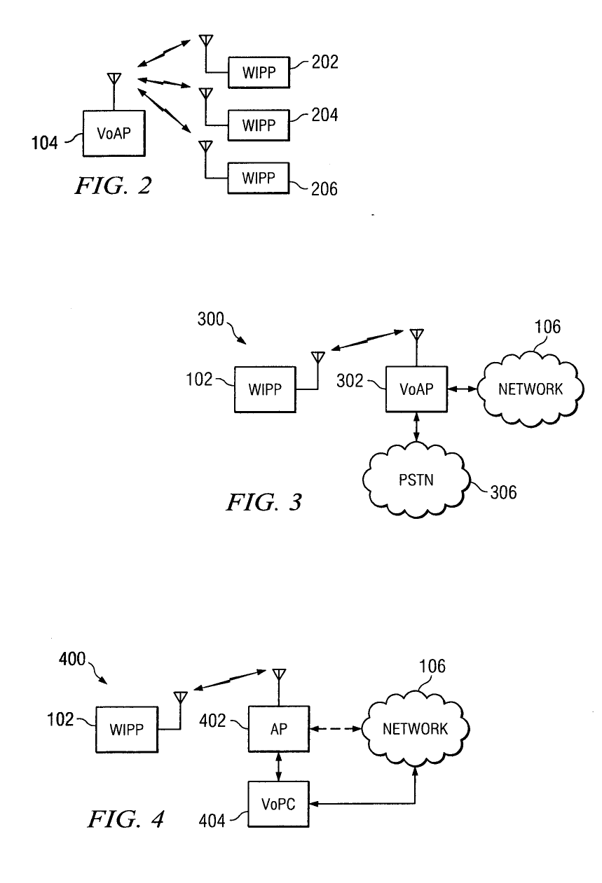

FIG. 2 illustrates the VoAP 104 communicating with multiple WIPPs 202, 204, and 206 simultaneously. Each of the WIPPs 202, 204, and 206 may individually communicate wirelessly with the VoAP 104 to establish separate VoIP calls. The VoAP 104 may enable multiple individual calls by providing a network address translation (NAT) function. For example, each of the WIPPs 202, 204, and 206 may be assigned an individual IP address on the WLAN. Upon receiving audio data, the VoAP 104 may use the NAT function to determine which WIPP the audio data belongs to and delivers the data to the corresponding WIPP. The NAT function may be implemented by the processor 114 of the VoAP 104. Also, the VoAP 104 may conference two or more of the WIPPs together. For example, WIPPs 202 and 204 may be conferenced into the same call while WIPP 206 communicates via another call. The VoAP 104 may enable a conference call by receiving audio data from each of the WIPPs 202 and 204 and the caller/callee communicating with the WIPPs, combining all of the audio data together, and broadcasting the combined audio data to all of the participants in the call.

FIG. 3 illustrates an embodiment of a VoIP communication system 300. The VoIP communication system 300 includes a WIPP 102, and a VoAP 302 with connections to both the public switched telephone network (PSTN) 306 and the IP network 106. The WIPP 102 may be implemented as described above. The VoAP 302 may include an RJ-11 interface for receiving calls directly from the PSTN 306 in a an IP network 308. In this case the WIPP 102 may act as both an IP phone as well as a black phone replacement. Alternatively, a black phone may be used in place of the WIPP 102 so that a customer may use their existing phone equipment for making VoIP calls.

FIG. 4 illustrates another embodiment of a VoIP communication system 400. The VoIP communication system 400 includes a WIPP 102, a wireless AP 402, a VoIP enabled personal computer (VoPC) 404, and an IP network 406. The AP 402 may be implemented as a conventional wireless router to simply act as a bridge for connecting the WIPP 102 to the VoPC 404. The VoPC 404 may implement all of the features of the VoAP 104 using the potentially greater resources of the VoPC 404. The VoPC 404 may implement functions of the GUI/Data server 118, the audio processor 112, and the audio hub 110 as software installed on the VoPC 404 or as dedicated hardware installed through an expansion slot on the VoPC 404. As illustrated, the VoPC 404 is connected to the network 106, however, the AP 402 may alternatively provide the connection to network 106.

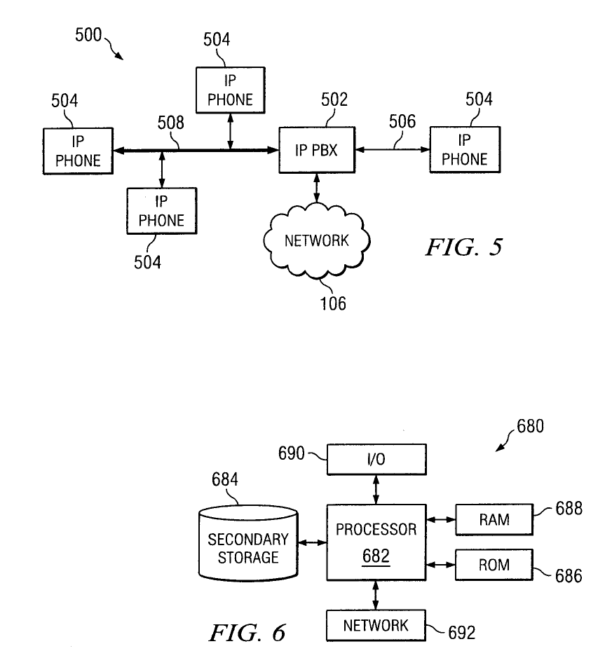

FIG. 5 illustrates another embodiment of a VOIP communication system 500. The VoIP communication system 500 includes an IP-PBX 502, a plurality of IP phones 504, a dedicated communication link 506, a shared communication link 508, and an IP network 106. The IP-PBX 502 may implement all of the features of the VoAP 104 described above in order to centralize processor-intensive functions needed for enabling VoIP calls. The IP-PBX 502 may provide VoIP call services to a number of IP phones 504 through the dedicated communication link 506 and/or the shared communication link 508. The IP phones 504 may be implemented similar to the WIPP 102 described above, relying on the IP-PBX 502 to perform a majority of the processing required for enabling a VoIP call. In some embodiments, the IP phone 504 may be minimally implemented without the display 142 or the GUI/Data client 140. In the minimal implementation, the memory 144 may be even smaller and the processor 128 may not require as much processing power or as many processing functions as in the embodiment illustrated in FIG. 1.

As described in some of the embodiments above, the IP phones 504 may be configured to communicate raw digital audio data with the IP-PBX 502. Upon receiving raw digital audio data from the IP-PBX 502, the IP phone 504 may directly produce audible sounds for a user to hear. Also, the IP phone 504 may sample ambient sounds produced by the user as raw digital audio data to be sent to the IP-PBX 502 for processing and routing over the IP network 106.

The dedicated communication link 506 and the shared communication link 508 may be implemented as differential lines such as a twisted pair line. As the communication between the IP-PBX 502 and each of the IP phones 504 may occur over differential lines, the IP-PBX 502 and the IP phones 504 may have differential drivers instead of a wireless communication driver 116 and wireless communication driver 126 respectively. The differential driver may implement a simple universal asynchronous receiver/transmitter (UART) interface, an RJ-11 interface, a wired Ethernet interface or any other such interface between the IP-PBX 502 and the IP phone 504.

In the embodiment shown in FIG. 5, some IP phones may directly communicate with the IP-PBX 502 through the dedicated communication link 506. Other IP phones may communicate with the IP-PBX 502 by sharing access to a shared communication link 508. The IP phones 504 may share access to the shared communication link 508 through a time divisional multiple access (TDMA) shared medium access protocol. For example, the dedicated communication link may be implemented as a time divisional multiplexed bus operating on a telephony clock rate generated by the IP-PBX 502. Each IP phone 504 may be assigned a particular time slot to communicate with the IP-PBX 502. In one embodiment, a custom packet-based interface between each IP phone 504 and the IP-PBX 502 may also be used by adding a telephony clock generator to each IP phone 504. In another embodiment, the IP-PBX 502 may coordinate access to the shared communication link 508 through polling or any other appropriate shared medium access control protocol. In another embodiment, each of the IP phones 504 may implement carrier sense multiple access (CSMA) or any other decentralized media access control protocol prior to communicating with the IP-PBX 502.

While a particular configuration of the VoIP communication system 500 is shown in FIG. 5, one skilled in the art will recognize that there may be many modifications without departing from the spirit or the scope of the disclosure. For example, the embodiment shown in FIG. 5 only illustrates a single dedicated communication link 506, however a plurality of IP phones 504 may communicate with the IP-PBX 502 through a plurality of dedicated communication links 506. Similarly, while only a single shared communication link 508 is shown in FIG. 5, the IP-PBX 502 may communicate with a plurality of IP phones 504 though a plurality of shared communication links 508. Also, while the embodiment shown in FIG. 5 illustrates a IP-PBX communicating through both shared and dedicated communication links 508 and 506, the VoIP communication system 500 may have only dedicated communication links 506 or only have shared communication links 508. In some embodiments the dedicated communication link 506 may be implemented as a wireless communication link through beamforming or any other directed wireless communication technique. Similarly, the shared communication link 508 may be implemented as wireless communication link through any appropriate wireless communication standard. It is also contemplated that a VoIP communication system may include both wired and wireless communication links. For example, the VoIP communication system 500 may include one or more WIPPs 102 as described above that wirelessly communicate directly with the IP-PBX 502 or with a wireless access point coupled to the IP-PBX 502 similar to the embodiment shown in FIG. 4. Also the IP-PBX 502 may communicate with the IP phones 504 via multiple standards. For example, the IP-PBX 502 may communicate with one IP phone 504 via an Ethernet connection and communicate with another IP phone 504 via an RJ-11 connection. When communicating wirelessly, the IP-PBX 502 may communicate with one IP phone 504 via a Bluetooth connection and communicate with another IP phone 504 via a WIFI connection.

Disclosed above are various embodiments of VoIP communication systems that utilize low cost IP phones that rely on a centralized VoIP controller for much of the processing. The VoIP controller may be implemented as any of a voice enabled AP (VoAP), voice enable PC (VoPC), IP private branch exchange (IP-PBX), or any other central controller for providing a majority of processing for enabling VoIP calls. Reducing the processing taking place on an IP phone may reduce the number of components that need to be on the IP phone which may result in a less expensive IP phone in terms of both cost and power. When the IP phone is embodied as a WIPP, reducing the processing taking place on the WIPP may also result in more efficient communication between the WIPP and an AP. The increased communication efficiency may result in less power being used by the WIPP and effectively extend the battery life and possible communication duration. Since a number of redundant components have been centralized, the VoIP system as a whole may be less costly. Also, centralized control may provide greater functionality and versatility in the setup and configuration of a VoIP communication system.

While many features and components were described above one skilled in the art will recognize that there may be many modifications to the VoIP communication systems described above without departing from the spirit or the scope of the disclosure. For example, the VoAP 104 and the WIPP 102 each have one antenna 122 for enabling communication with each other or any other wireless networks. In some embodiments the VoAP 104 and/or the WIPP 102 may alternatively have two or more antennas for improving the range, reliability, and throughput of wireless communications with the AP 104, for example, in accordance with the 802.11n specification. Also, while each of the audio hub 110, the audio processor 112, the processor 114, and the GUI/Data server 118 of the VoAP 104 were illustrated as separate components, all or some of these may be incorporated into a dedicated VoAP 104 processor. Similarly, the processor 128 and the GUI/Data client 140 on the WIPP 102 may be incorporated into a single processor. Further, while each of the features, services, and configurations of the VoIP communication systems were separately described, one skilled in the art will recognize that the features, services, and configurations may be grouped or combined in any way.

Each of the VoAP 104, VoAP 302, the VoPC 404, and the IP-PBX 502 described above may be implemented on any general-purpose computer with sufficient processing power, memory resources, and network throughput capability to handle the necessary workload placed upon it. FIG. 6 illustrates a typical, general-purpose computer system suitable for implementing one or more embodiments disclosed herein. The computer system 680 includes a processor 682 (which may be referred to as a central processor unit or CPU) that is in communication with memory devices including secondary storage 684, read only memory (ROM) 686, random access memory (RAM) 688, input/output (I/O) 690 devices, and network connectivity devices 692. The processor may be implemented as one or more CPU chips.

The secondary storage 684 is typically comprised of one or more disk drives or tape drives and is used for non-volatile storage of data and as an over-flow data storage device if RAM 688 is not large enough to hold all working data. Secondary storage 684 may be used to store programs which are loaded into RAM 688 when such programs are selected for execution. The ROM 686 is used to store instructions and perhaps data which are read during program execution. ROM 686 is a non-volatile memory device which typically has a small memory capacity relative to the larger memory capacity of secondary storage. The RAM 688 is used to store volatile data and perhaps to store instructions. Access to both ROM 686 and RAM 688 is typically faster than to secondary storage 684.

I/O 690 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 692 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 692 devices may enable the processor 682 to communicate with an Internet or one or more intranets. With such a network connection, it is contemplated that the processor 682 might receive information from the network, or might output information to the network in the course of performing the above-described method steps. Such information, which is often represented as a sequence of instructions to be executed using processor 682, may be received from and outputted to the network, for example, in the form of a computer data signal embodied in a carrier wave

Such information, which may include data or instructions to be executed using processor 682 for example, may be received from and outputted to the network, for example, in the form of a computer data baseband signal or signal embodied in a carrier wave. The baseband signal or signal embodied in the carrier wave generated by the network connectivity 692 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 682 executes instructions, codes, computer programs, scripts which it accesses from hard disk, floppy disk, optical disk (these various disk based systems may all be considered secondary storage 684), ROM 686, RAM 688, or the network connectivity devices 692.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A central voice over internet protocol (VoIP) controller, comprising:
a communication driver configured to communicate raw digital audio data in accordance with a communication protocol;
an audio processor configured to process digital audio data;
an audio hub configured to append headers to the digital audio data and to route outgoing audio data over an internet protocol (IP) network and depacketize incoming audio data from the IP network; and
an IP network interface configured to communicate packetized digital audio data.

2. The central VoIP controller of claim 1, wherein the raw digital audio data raw digital audio data includes digital audio data that has not had a majority of processing applied or does not require a majority of decoding or processing prior to being converted into audio signals and output by a speaker.

3. The central VoIP controller of claim 1, wherein the audio processing includes encryption, echo cancellation, encoding or decoding the digital audio data in accordance with a codec, jitter compensation, tone generation, and tone detection.

4. The central VoIP controller of claim 1, wherein the communication protocol is a wireless communication protocol or a wired communication protocol.

5. The central VoIP controller of claim 1, wherein the headers include any of real-time transport protocol (RTP), user datagram protocol (UDP), and IP headers.

6. The central VoIP controller of claim 1, further comprising:
a server configured to enable graphical user interface (GUI) and data services to one or more clients; and
a memory configured to store data in support of the GUI and data services.

7. The central VoIP controller of claim 6, wherein the server is configured as a web server or daemon web browser.

8. The central VoIP controller of claim 6, wherein the data stored in the memory includes GUI icons, images, screen layouts, process flows, address book entries, and instant messaging buddy lists.

9. The central VoIP controller of claim 6, wherein the memory is further configured to buffer the digital audio data, and wherein the audio processor is further configured to restructure the buffered audio data to mitigate the effects of jitter.

10. The central VoIP controller of claim 6, wherein the server is configured to enable web browsing and instant messaging on the clients.

11. An IP phone configured to communicate VoIP calls, comprising:
a communication driver configured to send and receive raw digital audio data in accordance with a communication protocol;
a digital-to-analog (D/A) converter for converting received raw digital audio data into audio signals;
a speaker for audibly outputting the audio signals converted by the D/A converter;
a user input device configured to receive user inputs;
a user feedback device configured to provide audio, visual, and/or kinetic feedback;
a microphone for detecting ambient audible sounds as audio signals; and
an analog-to-digital (A/D) converter for converting the ambient audio signals into the raw digital audio data that is sent by the communication driver.

12. The IP phone of claim 11, wherein the raw audio data does not have a majority of processing applied prior to being sent by the communication driver or does not require a majority of decoding or processing after being received by the communication driver.

13. The IP phone of claim 11, wherein the communication protocol is a wireless communication protocol or a wired communication protocol.

14. The IP phone of claim 11, wherein the communication driver is further configured to send data corresponding to the user inputs.

15. The IP phone of claim 14, wherein the user feedback device is a display configured to display GUI screens and supporting data received by the communication driver in response to the sent data.

16. The IP phone of claim 14, wherein the user inputs select operation states of the IP phone to initiate a VoIP call, accept an incoming VoIP call, or reject an incoming VoIP call.

17. A VoIP communication method, comprising:
communicating with at least one IP phone to send raw digital audio data and user input data and receive raw digital audio data and graphical user interface data;
receiving with a central VoIP controller the raw digital audio data and the user input data sent by the at least one IP phone and incoming digital audio data from an IP network;
processing the received raw digital audio data and the incoming digital audio data with the central VoIP controller;
sending the processed incoming digital audio data with the central VoIP controller to be received by the at least one IP phone as the received raw digital audio data;
sending the GUI data with the central VoIP controller responsive to the received user input data; and
routing the processed raw audio data over the IP network with the central VoIP controller.

18. The VoIP communication method of claim 17, wherein communication between the central VoIP controller and the at least one IP phone is over a wired or wireless communication medium.

19. The VoIP communication method of claim 17, wherein at least two IP phones are engaging in separate VoIP calls.

20. The VoIP communication method of claim 17, wherein at least two IP phones are conferenced together by the central VoIP controller to engage in a single VoIP call.

21. A system for managing VoIP calls, comprising:
a memory configured to store computer readable instructions;
a programmable processor coupled to the memory and configured to execute the instructions, the instructions comprising:
receiving raw digital audio data and user input data sent by at least one IP phone;
receiving incoming digital audio data from an IP network;
processing the received raw digital audio data and the incoming digital audio data;
sending the processed incoming digital audio data to be received by the at least one IP phone as raw digital audio data;
sending GUI data responsive to the received user input data; and
routing the processed raw audio data over the IP network.

22. The system of claim 21, wherein the sending and the receiving data with the at least one IP phone is over a wired or wireless communication medium.

23. The system of claim 21, wherein at least two IP phones are engaging in separate VoIP calls.

24. The system of claim 21, wherein at least two IP phones are conferenced together by the central VoIP controller to engage in a single VoIP call.
